(19) United States
(12) Patent Application Publication
(10) Pub. No.: US 2020/0279566 A1
(43) Pub. Date: Sep. 3, 2020

(54) CONTROL SYSTEM

(71) Applicant: Toshiba Lifestyle Products & Services Corporation, Kawasaki-shi (JP)

(72) Inventors: Tsubasa WASHIZAKI, Toyota-shi (JP); Yuuki MARUTANI, Nagakute-shi (JP); Yukio MACHIDA, Owariasahi-shi (JP); Hiroaki KAWAGUCHI, Kasugai-shi (JP); Yoshihiko UJITA, Owariasahi-shi (JP); Kengo MATSUNAGA, Nagoya-shi (JP)

(73) Assignee: Toshiba Lifestyle Products & Services Corporation, Kawasaki-shi (JP)

(21) Appl. No.: 16/651,014

(22) PCT Filed: Aug. 27, 2018
(86) PCT No.: PCT/JP2018/031590

§ 371 Date: Mar. 26, 2020

(30) Foreign Application Priority Data
Oct. 3, 2017 (JP) 2017-193542

(51) Int. Cl. G10L 17/00; H04L 12/28; G10L 17/02; G10L 25/78

(52) U.S. Cl. CPC G10L 17/005; G10L 25/78; G10L 17/02; H04L 12/283

(57) ABSTRACT

A control system includes a detector configured to detect speech of a plurality of users and a controller. The controller is configured to specify an attribute of the user who spoke based on a content and/or voice of the speech of the user detected by the detector, and output notification information suitable for the attribute and/or execute control suitable for the attribute.

### TECHNICAL FIELD

The art disclosed herein relates to a control system.

### BACKGROUND ART

Patent Document 1 describes an air conditioner provided with a speech recognition means and an operation control means. In this air conditioner, when a speech recognized by the speech recognition means is a control instruction, the operation control means controls operation of the air conditioner based on a speech recognition result thereof.

### CITATION LIST

[Patent Document 1] JP 5020222 B

### SUMMARY OF INVENTION

### Technical Problem

A home appliance such as an air conditioner may be installed in a house. Further, in a general household, a plurality of users who use the home appliance is present, and each user may have unique demand to the home appliance. Thus, in the description herein, an art that enables to meet demand suitable for an attribute of each user even in a case where users with various attributes are present.

### Solution to Technical Problem

The control system disclosed herein comprises a detector configured to detect speech of a plurality of users and a controller. The controller is configured to specify an attribute of the user who spoke based on a content and/or voice of the speech of the user detected by the detector, and output notification information suitable for the attribute and/or execute control suitable for the attribute.

### BRIEF DESCRIPTION OF DRAWINGS

FIG. 1 is a diagram schematically showing a configuration of a control system of a first embodiment.

FIG. 2 is a diagram schematically showing a configuration of a detector of the first embodiment.

FIG. 3 is a block diagram showing the configuration of the detector of the first embodiment.

FIG. 4 is a table showing an example of a corresponding relationship between keywords included in a content of speech of the user and home appliances.

FIG. 5 is a table showing an example of a corresponding relationship between users, their attributes, and notification information (1).

FIG. 6 is a sequence diagram showing processes executed in the control system of the first embodiment.

FIG. 7 is a table showing an example of a corresponding relationship between the users, their attributes, and the notification information (2).

FIG. 8 is a table showing an example of a corresponding relationship between the users, their attributes, and control contents (1).

FIG. 9 is a table showing an example of a corresponding relationship between the users, their attributes, and the control contents (2).

FIG. 10 is a table showing an example of a corresponding relationship between the users and trigger words.

FIG. 11 is a diagram schematically showing a configuration of a control system of a third embodiment.

FIG. 12 is a sequence diagram showing processes executed in a control system of a fourth embodiment.

### DESCRIPTION OF EMBODIMENTS

### First Embodiment

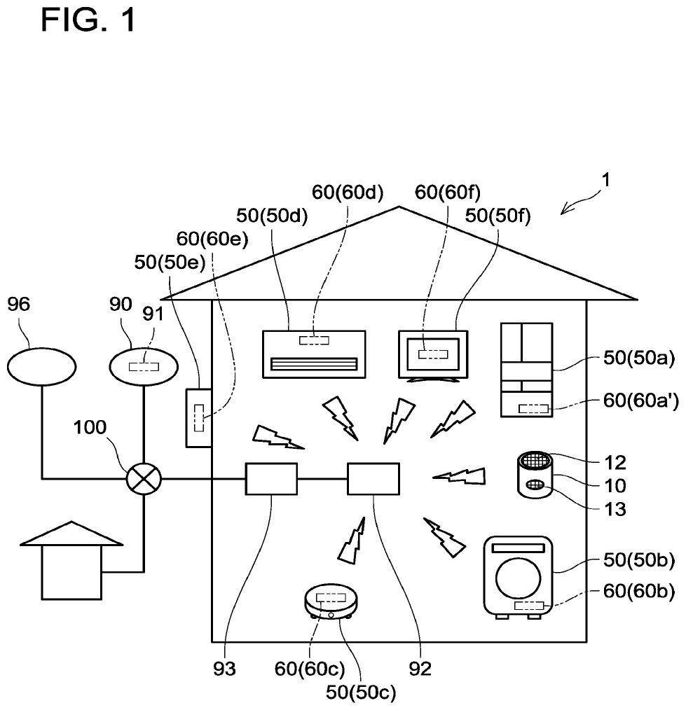

A control system 1 of an embodiment will be described in detail with reference to the drawings. As shown in FIG. 1, the control system 1 of the first embodiment is provided with a detector 10 and a plurality of home appliances 50 (50a. 50b. 50c, 50d, 50e, 50f).

The detector 10 is disposed in a living room of a house, for example. A position where the detector 10 is to be disposed is not particularly limited, and the detector 10 may for example be disposed in one of a kitchen, a dining room, a bedroom, and a nursery room of the house. The detector 10 is capable of wirelessly communicating with the plurality of home appliances 50 (50a, 50b, 50c, 50d, 50e, 50f) disposed in the house. A communication scheme of the detector 10 and the home appliances 50 is not particularly limited. Further, the detector 10 is connected to an external first server 90 through a wireless router 92, a modem 93, and the Internet 100, and is capable of communicating with the external first server 90. The detector 10 may be capable of communicating with the plurality of home appliances 50 through the first server 90. The first server 90 is connected to an external second server 96 through the Internet 100. The first server 90 is provided with a controller 91.

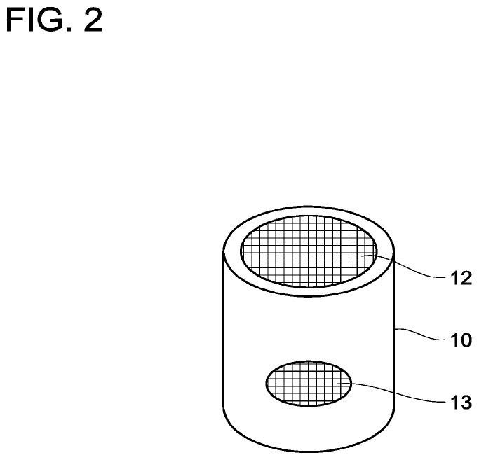

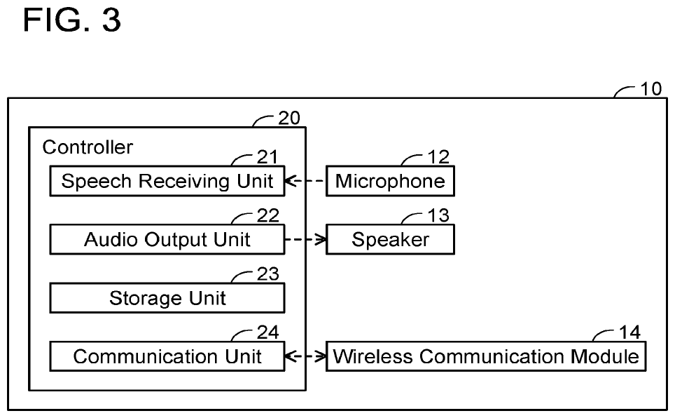

As shown in FIG. 2, the detector 10 is provided with a microphone 12 and a speaker 13. Further, as shown in FIG. 3, the detector 10 is provided with a wireless communication module 14 and a controller 20. The detector 10 is a device configured to detect speech of users of the control system 1.

The microphone 12 of the detector 10 is a device configured to acquire sounds in a surrounding of the detector 10. When the users of the control system 1 speak in the surrounding of the detector 10, speech thereof are acquired by the microphone 12. The microphone 12 may for example be configured to acquire speech in a range of 5 meters radius from the detector 10. The speech acquired by the microphone 12 is sent to the controller 20 of the detector 10.

The speaker 13 of the detector 10 is a device configured to output audio to the surrounding of the detector 10. The speaker 13 is configured to notify information to the users of the control system 1 by audio. For example, the speaker 13 notifies information related to the home appliances 50 in audio to the users who are present in the surrounding of the detector 10. The users who are present in the surrounding of the detector 10 can acknowledge the information notified by the audio outputted from the speaker 13.

The wireless communication module 14 of the detector 10 is provided for wireless communication with the plurality of home appliances 50 and the wireless router 92. Transmission and reception of information are executed through the wireless communication module 14.

The controller 20 of the detector 10 is provided with a speech receiving unit 21, an audio output unit 22, a storage unit 23, and a communication unit 24. The speech receiving unit 21 of the controller 20 is configured to receive signals of speech acquired by the microphone 12 from the microphone 12. Further, the audio output unit 22 is configured to output a signal of audio to be outputted to the surrounding of the detector 10 to the speaker 13. Further, the communication unit 24 is configured to execute transmission and reception of information through the wireless communication module 14. Further, the storage unit 23 stores analytic speech data for analyzing the speech which the speech receiving unit 21 received from the microphone 12. Details of control executed by the controller 20 of the detector 10 will be described later.

As shown in FIG. 1, the plurality of home appliances 50 in the control system 1 is connected to the external first server 90 through the wireless router 92, the modem 93, and the Internet 100, and is capable of communicating with the external first server 90. Each of the home appliances 50 is provided with a communication unit that is not shown. The plurality of home appliances 50 in the control system 1 may for example be a refrigerator 50a, a laundry machine 50b, a robotic vacuum cleaner 50c, an air conditioner 50d, a water heater 50e, and a TV 50f. Each of the home appliances 50 (50a, 50b, 50c, 50d, 50c, 50f) is provided with a controller 60 (60a, 60b, 60c, 60d, 60e, 60f). Types of the home appliances 50 are not particularly limited, and may for example be a microwave, a rice cooker, a Blu-ray disk player, and a DVD player.

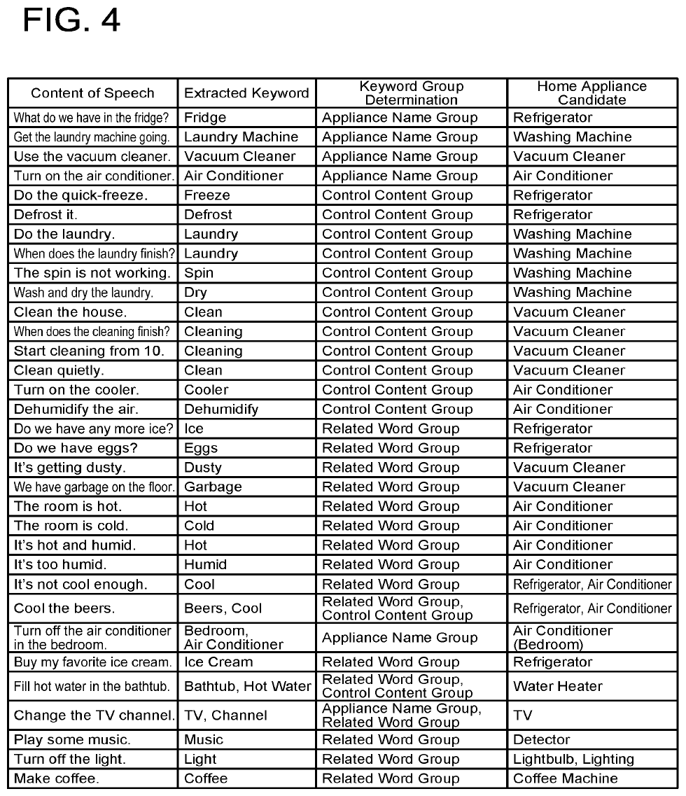

Next, the speech of the users of the control system 1 will be described. In the house, the users of the control system 1 say various things. In such occasions, contents of the speech of the users may be related to one or more home appliances 50 in the control system 1. Specifically, as shown in FIG. 4, a keyword included in the speech of a user may be related to one or more home appliances 50. For example, the user may say: “what do we have in the fiidge?”, “wash and dry the laundry.”, “clean the room.”, “this room is hot.”, “cool the beers.”, and the like. When the user says “what do we have in the fridge?” or “cool the beers.”, for example, the content of such speech is related to the refrigerator 50a. Further, when the user says “wash and dry the laundry.”, the content of such speech is related to the laundry machine 50b. Further, when the user says “change the TV channel.”, the content of such speech is related to the TV 50f. The keywords included in the respective contents of speech of the user are related to the respective home appliances 50. The corresponding relationship of the contents of speech, the keywords, and the home appliances 50 shown in FIG. 4 is a mere example and does not cast any particular limitation.

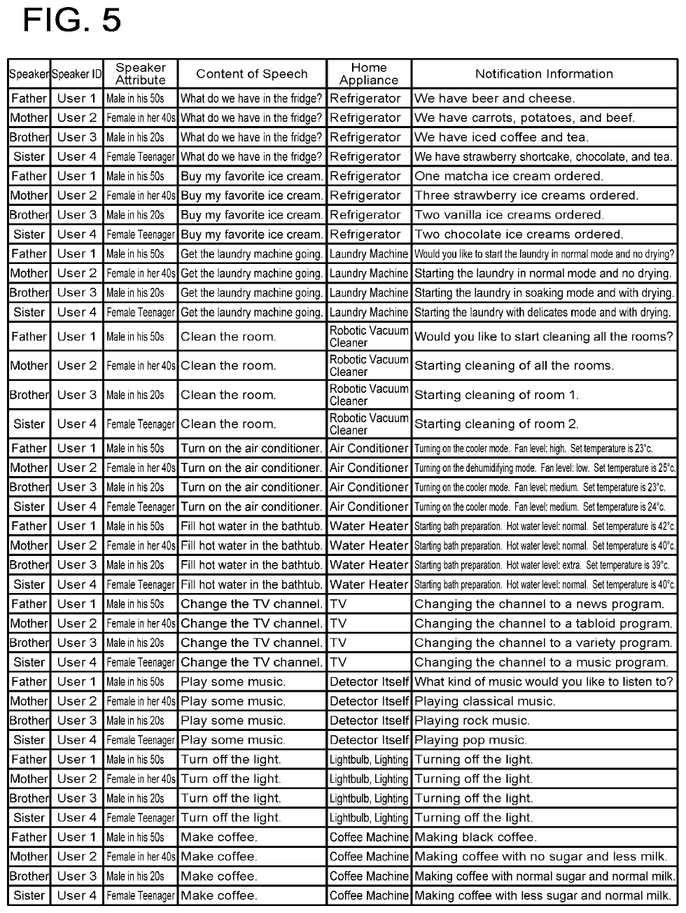

Further, a plurality of users who uses the control system 1 is present in a household. For example, as shown in FIG. 5, users 1 to 4 (for example, father, mother, brother, and sister) are present in the household. Each of the users 1 to 4 of the control system 1 has respective attributes. For example, the user 1 has the attribute of a male his 50s. Further, the user 2 has the attribute of a female in her 40s. The corresponding relationship of the users and the attributes shown in FIG. 5 is a mere example and does not cast any particular limitation. In the house, the users 1 to 4 of the control system 1 say various things. For example, among the plurality of users 1 to 4, the user 1 may say “what do we have in the fridge?” and “cool the beers.”. Further, another user 2 may say “change the TV channel.”. In the above control system 1, various processes are executed based on the speech of the users. This will be described hereinbelow.

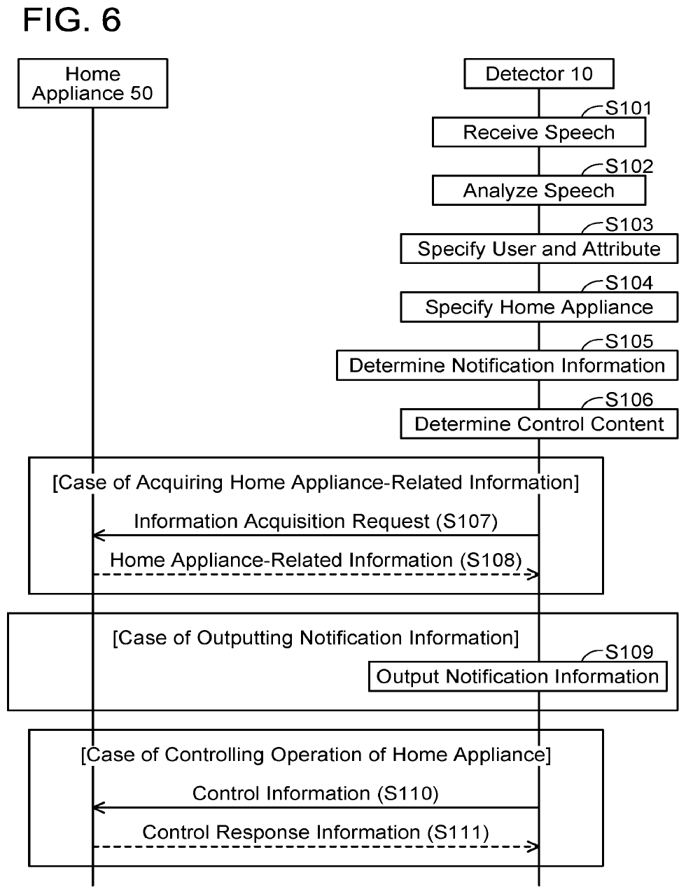

Next, the processes executed in the control system 1 will be described. As shown in FIG. 6, when a power of the detector 10 is turned on, the control system 1 firstly executes a process of step S101. In step S101, the speech receiving unit 21 of the detector 10 receives a speech of speech of a user of the control system 1. In the home appliances system 1, when the user says something, the microphone 12 of the detector 10 acquires the speech thereof and sends the same to the controller 20. For example, when the user 1 of the control system 1 says “what do we have in the fridge?” and “cool the beers.”, the microphone 12 of the detector 10 acquires the speech thereof and sends the same to the controller 20. Then, the speech receiving unit 21 of the controller 20 receives the speech thereof (“what do we have in the fridge?” and “cool the beers.”).

Next in step S102, the controller 20 executes analysis on the speech received by the speech receiving unit 21 by using the analytic speech data stored in the storage unit 23. The controller 20 analyzes the speech and extracts the keywords included therein. For example, the controller 20 analyzes the speech “what do we have in the fridge?” received by the speech receiving unit 21 and extracts the keyword “fridge” included in the speech (see FIG. 4). Further, the controller 20 analyzes the speech “cool the beers.” received by the speech receiving unit 21 and extracts the keywords “beers” and “cool” included in the speech. The keyword “fridge” is a keyword in an appliance name group. Further, the keyword “beer” is a keyword in a related word group, and the keyword “cool” is a keyword in a control content group.

As shown in FIG. 6, next in step S103, the controller 20 of the detector 10 specifies the user who spoke what that was detected by the detector 10 and his/her attribute. The controller 20 specifies the user and his/her attribute based on speech analysis using the analytic speech data. For example, the controller 20 executes analysis on a frequency of the voice that was received by the speech receiving unit 21 (“what do we have in the fridge?” and “cool the beers.”) and specifies the user who spoke and his/her attribute by vocal print analysis and the like. If the user 1 among the plurality of users 1 to 4 had said “what do we have in the fridge?” and “cool the beers.”, the controller 20 specifies the user 1. Further, the controller 20 specifies the attribute of the user 1 (such as a male in his 50s).

Next in step S104, the controller 20 specifies the home appliance 50 related to the keyword(s) based on the keyword(s) extracted by the speech analysis. For example, the controller 20 specifies the home appliance 50 related to the extracted keyword “fridge”, that is, the “refrigerator 50a”, from among the plurality of home appliances 50 in the control system 1 (see FIG. 4). Further, based on the extracted keywords “beers” and “cool”, the controller 20 may specify the “refrigerator 50a” related to these keywords.

Next in step S105, the controller 20 determines notification information. The controller 20 determines the notification information suitable for the user and attribute specified in the above step S103. Further, the controller 20 determines the notification information suitable for the home appliance 50 specified in the above step S104. For example, in a case where the user 1 is specified in the above step S103 and the refrigerator 50a is specified in the above step S104, the controller 20 determines the notification information to be “we have beer and cheese.” (see FIG. 5). The notification information “we have beer and cheese.” is information that is most suitable for the user 1 among the plurality of users 1 to 4. Further, this notification information is information that is most suitable for the attribute of male in 50s. Further, this notification information is information that is most suitable for the refrigerator 50a among the plurality of home appliances 50.

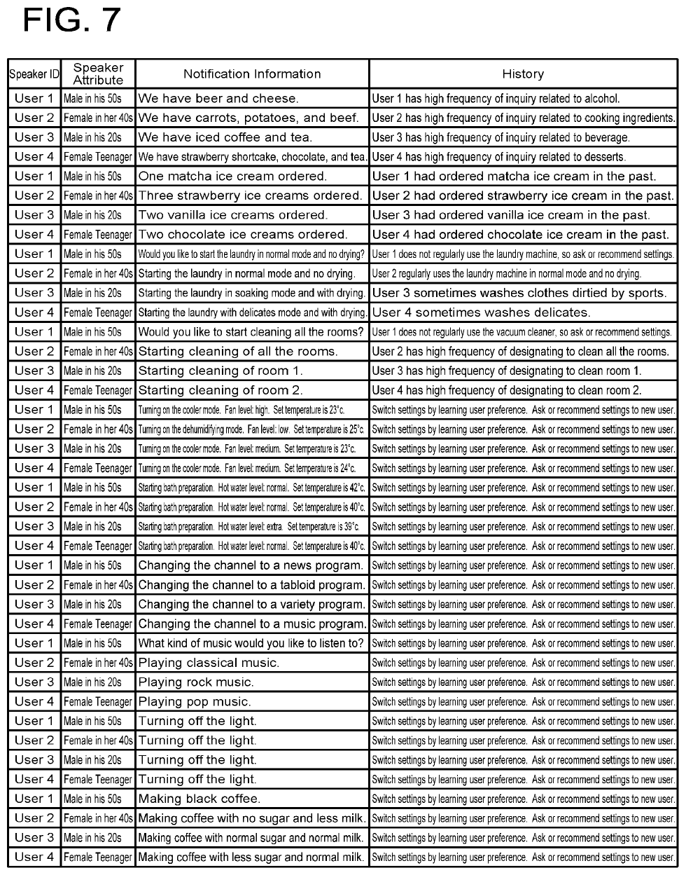

In step S105, the controller 20 determines the notification information that is suitable for the user and his/her attribute according to a predetermined algorithm prestored in the storage unit 23 and machine learning. For example, the controller 20 may execute a predetermined information process based on a past action history of the user and determine the notification information suitable for this user. Further, the controller 20 may determine the notification information suitable for this user based on a preset program. Moreover, the controller 20 may determine the notification information suitable for this user based on predetermined learning data. For example, in the case where the user 1 is specified in the above step S103, the controller 20 determines the notification information “we have beer and cheese.” suitable for the user 1 since the user 1 has a high frequency of inquiries related to alcohol to the detector 10 in the past (see FIG. 7). Further, for example, in a case where the user 2 is specified in the above step S103, the controller 20 determines the notification information “we have carrots, potatoes, and beef.” suitable for the user 2 since the user 2 has a high frequency of inquiries related to cooking ingredients to the detector 10 in the past (see FIG. 7).

Further, for example, in a case where the user 1 is specified in the above step S103 and the TV 50f is specified as the home appliance 50 in the above step S104, the controller 20 determines the notification information “switching the channel to a news program.”, for example, in step S105 (see FIG. 5). The notification information “switching the channel to a news program.” is information that is most suitable for the user 1 among the plurality of users 1 to 4. Further, this notification information is information that is most suitable for the attribute of male in 50s. Further, this notification information is information that is most suitable for the TV 50f among the plurality of home appliances 50. The controller 20 determines the notification information based on information prestored in the storage unit 23 and machine learning. For example, in a case where the user 1 had a preference of watching news programs in the past (see FIG. 7), the controller 20 leans this preference of the user 1 and determines the notification information “switching the channel to a news program.” that is suitable for the user 1.

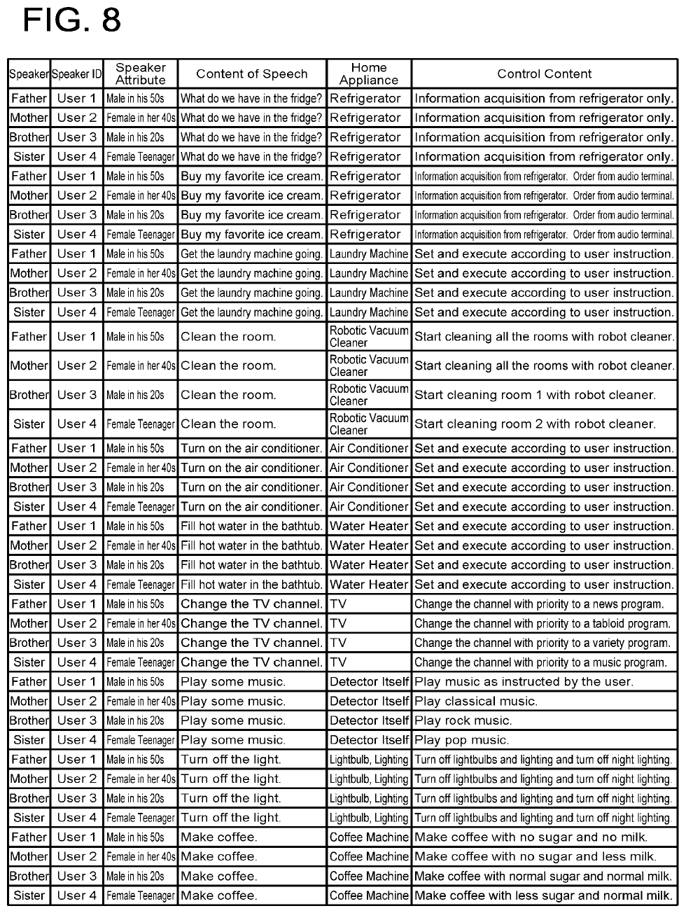

Next, as shown in FIG. 6, in step S106, the controller 20 determines a control content for the home appliance 50 specified in the above step S104. In doing so, the controller 20 determines the control content suitable for the user and attribute specified in the above step S103. For example, in the case where the user 1 is specified in the above step S103 and the TV 50f is specified in the above step S104, the controller 20 determines the control content to “change the channel with priority to a news program.”, for example (see FIG. 8). The control content to “change the channel with priority to a news program.” is a control that is most suitable for the user 1 among the plurality of users 1 to 4. Further, this control content is information that is most suitable for the attribute of male in 50s. Further, this control content is information that is most suitable for the TV 50f among the plurality of home appliances 50.

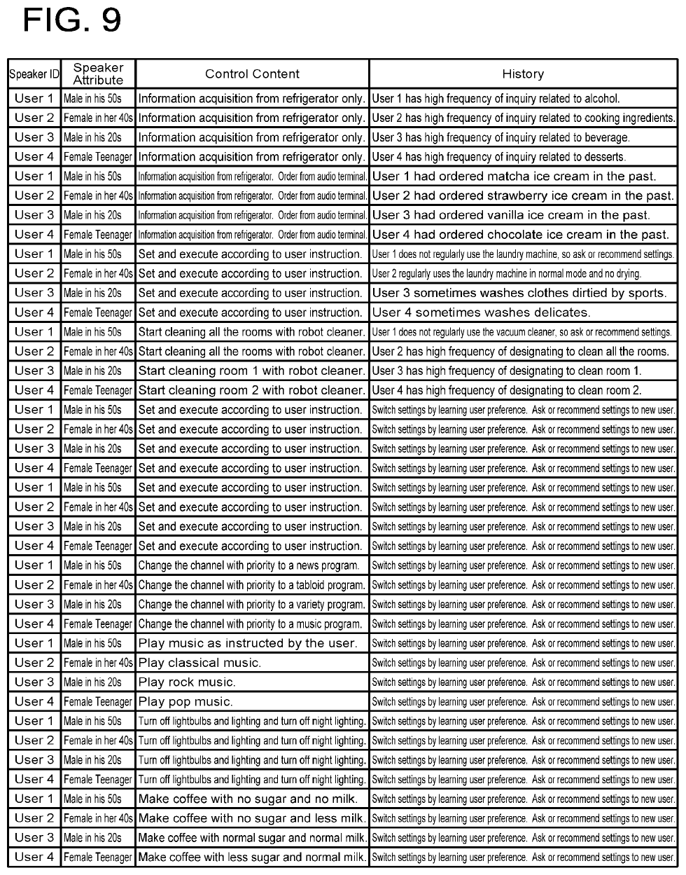

In step S106, the controller 20 determines the control content suitable for the user and his/her attribute according to a predetermined algorithm prestored in the storage unit 23 and machine learning. For example, the controller 20 may execute a predetermined information process based on the past action history of the user and determine the control content suitable for this user. Further, the controller 20 may determine the control content suitable for this user based on a preset program. Moreover, the controller 20 may determine the control content suitable for this user based on predetermined learning data. For example, in the case where the user 1 is specified in the above step S103 and the user 1 had the preference of watching news programs in the past, the controller 20 learns this preference of the user 1 and determines the control content to “change the channel with priority to a news program.” that is suitable for the user 1 (see FIG. 9). Further, for example, in the case where the user 2 is specified in the above step S103 and the user 2 had a preference of watching tabloid programs in the past, the controller 20 leans this preference of the user 2 and determines the control content to “change the channel with priority to a tabloid program.” that is suitable for the user 2 (see FIG. 9).

Then, as shown in FIG. 6, in a case of acquiring the home appliance-related information, the controller 20 of the detector 10 executes a process of step S107. The home appliance-related information is information related to the home appliance 50 (for example, the refrigerator 50a or the TV 50f) specified by the controller 20 in the above step S104. When the home appliance 50 is the refrigerator 50a, the home appliance-related information includes the information on the articles within the compartment of the refrigerator 50a and the information of the temperature in the compartment, for example. Further, for example, when the home appliance 50 is the TV 50f, the home appliance-related information includes information of a current channel of the TV 50f, for example.

In step S107, the controller 20 of the detector 10 sends the information acquisition request to the home appliance 50 (such as the refrigerator 50a or the TV 501). The controller 60 of the home appliance 50 receives this information acquisition request. Then, in step S108, the controller 60 of the home appliance 50 sends the home appliance-related information to the detector 10 in response to the received information acquisition request. This home appliance-related information is received by the controller 20 of the detector 10.

Next, in a case of outputting the notification information (such as “we have beer and cheese.” or “switching the channel to a news program.”) determined in the above step S105, the controller 20 of the detector 10 executes a process of step S109. In step S109, the controller 20 outputs the notification information determined in the above step S105 to the speaker 13 from the audio output unit 22. Audio of the notification information (such as “we have beer and cheese.” or “switching the channel to a news program.”) is outputted from the speaker 13 of the detector 10 to the surrounding of the detector 10. Due to this, the notification information is notified to the user 1 of the control system 1, and the user 1 can acknowledge the notification information.

Next, in a case of controlling the operation of the home appliance 50 specified in the above step S104 (such as TV 50f), the controller 20 of the detector 10 executes a process of step S110. The controller 20 operates the operation of the home appliance 50 (such as TV 50f) based on the control content determined in the above step S106 (such as “change the channel with priority to a news program.”).

In step S110, the controller 20 of the detector 10 sends control information to the home appliance 50 (such as TV 50f). This control information is received by the controller 60 of the home appliance 50. The control information is information related to the control content of the home appliance 50 (such as TV 50f). The control information includes information for changing the channel of the TV 50f, for example. Next in step S111, the controller 60 of the home appliance 50 sends control response information to the detector 10 in response to the received control information. This control response information is received by the controller 20 of the detector 10. Further, the controller 60 of the home appliance 50 executes control of its operation based on the received control information. For example, the controller 60f of the TV 50f executes the control to change the channel of the TV 50f.

As above, the control system of the first embodiment has been described. As it is apparent from the foregoing explanation, the control system 1 is provided with the detector 10 configured to detect the speech of the plurality of users 1 to 4, and the controller 20 in the detector 10. The controller 20 is configured to specify the attribute (such as being a male in his 50s) of the user who spoke based on the content and/or voice of the speech of the user detected by the detector 10, and output the notification information suitable for the attribute (such as “we have beer and cheese.”, “switching the channel to a news program.”). Further, the controller 20 is configured to specify the user who spoke (such as the user 1) based on the voice of the speech of the user, and output the notification information suitable for this user. Further, the controller 20 is configured to execute the control suitable for the specified user and his/her attribute (such as “change the channel with priority to a news program.”).

According to this configuration, for example, in the case where the user 1 who is a male in his 50s says “what do we have in the fridge?”, the notification information “we have beer and cheese.” suitable for this user 1 and his/her attribute is outputted. Further, for example, in the case where the user 1 who is a male in his 50s says “change the TV channel.”, the notification information “switching the channel to a news program.” suitable for this user 1 and his/her attribute is outputted. Further, the control to “change the channel with priority to a news program.” that is suitable for this user 1 and his/her attribute is executed. Due to this, even in the case where there are the users 1 to 4 with various attributes, each of the users 1 to 4 can obtain information that is suitable for his/her attribute. Each of the users 1 to 4 can obtain information that is suitable for himself/herself. Further, the control that is suitable for each of the users 1 to 4 and his/her attribute can be executed. Thus, the control system 1 can suitably meet demands of each user and his/her attribute. Alternatively, the controller 20 may be configured to execute only one of outputting and controlling of the notification information.

Further, in the above control system 1, the controller 20 is configured to output the notification information suitable for the user regarding the home appliance 50. Further, the controller 20 is configured to execute the control suitable for the user regarding the home appliance 50. Due to this, each of the users 1 to 4 can obtain information that is suitable for the home appliance 50. Further, the control that is suitable for the home appliance 50 can be executed.

Further, in the above control system 1, the controller 20 of the detector 10 is configured to output the notification information suitable for the specified user (such as the user 1) based on the past action history of the specified user (such as the action history of having the high frequency of inquiries related to alcohol to the detector 10 in the past). Due to this, each of the users 1 to 4 can obtain suitable information based on the past action history.

One specific embodiment has been described above, however, specific configuration is not limited to the foregoing embodiment. In the description below, configurations that are same as the configurations in the foregoing description will be given same reference signs and descriptions thereof will be omitted.

In the above embodiment, the controller 20 of the detector 10 outputs the notification information regarding the home appliance 50, however, no limitation is made to this configuration. In another embodiment, the controller 20 may output notification information on the detector 10 itself instead of the home appliance 50. Further, the controller 20 may execute control of the detector 10 itself instead of the home appliance 50. For example, as shown in FIG. 5, in a case where the user 2 of the control system 1 says “play some music.”, the controller 20 outputs the notification information “playing classical music.” that is suitable for the user 2. This notification information is notification information on the detector 10 itself rather than the home appliance 50. Further, in this case, as shown in FIG. 7, the controller 20 executes the control of “play classical music.”. This control is a control on the detector 10 itself rather than the home appliance 50. The control system 1 may not be provided with the plurality of home appliances 50.

Further, in the above embodiment, the controller 20 of the detector 10 specifies the user and his/her attribute based on the voice of the speech of the user, however, no limitation is cast upon this configuration. In another embodiment, the user and his/her attribute may be specified based on the content of the speech instead of the voice of the speech of the user. The controller 20 of the detector 10 specifies the user and his/her attribute by the analytic speech data and a predetermined algorithm prestored in the storage unit 23 and machine learning. Further, the controller 20 may specify the user and his/her attribute based on a combination of the content of the speech and the voice of the user.

### Second Embodiment

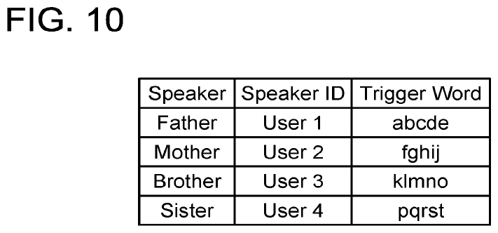

In the second embodiment, the controller 20 of the detector 10 may specify the user based on a user-specific trigger word included in the speech of the user. The user-specific trigger word is a word for specifying the user. For example, as shown in FIG. 10, a corresponding relationship between the users and the trigger words is preset and this corresponding relationship is stored in the storage unit 23. In this state, when the user 1 of the control system 1 says the trigger word (“abcde”) unique to the user 1, for example, the controller 20 specifies the user 1 based on this trigger word (“abcde”). Further, when the user 2 says the trigger word (“fghij”) unique to the user 2, for example, the controller 20 specifies the user 2 based on this trigger word (“fghij”). Further, the controller 20 of the detector 10 outputs the notification information (such as “we have beer and cheese.”, “switching the channel to a news program.”) suitable for the user specified based on the trigger word (such as the user 1) (see FIGS. 5 and 6). Further, the controller 20 executes the control suitable for the specified user (such as to “change the channel with priority to a news program.”) (see FIGS. 6 and 8).

### Third Embodiment

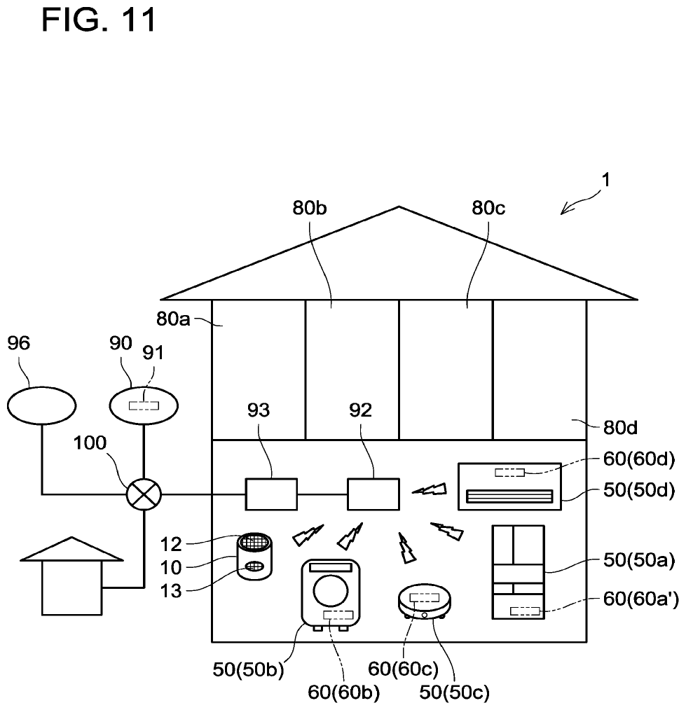

In the third embodiment, the controller 20 of the detector 10 may execute control of the home appliance 50 based on positional information associated with the user specified in the above step S103. For example, as shown in FIG. 11, a plurality of rooms (such as a room 80a of the user 1, a room 80b of the user 2, a room 80c of the user 3, a room 80d of the user 4, etc.) is present in the house, and it is hereby assumed that the positional information of the room 80a of the user 1 is associated with the user 1 thereamong. Further, when the controller 20 specifies the user 1 in the above step S103, the control of the home appliance 50 is executed based on the positional information of the room 80a of the user associated with the user 1. For example, in a case of having specified the robotic vacuum cleaner 50c in the above step S104, the controller 20 executes the control of the robotic vacuum cleaner 50c to clean the room 80a of the user 1. The controller 20 executes control of the robotic vacuum cleaner 50c for the rooms 80b to 80d of the other users 2 to 4 as well, based on the positional information respectively associated with the users 2 to 4. According to this configuration, suitable service can be provided in regard to the rooms 80a to 80d of the respective users 1 to 4.

### Fourth Embodiment

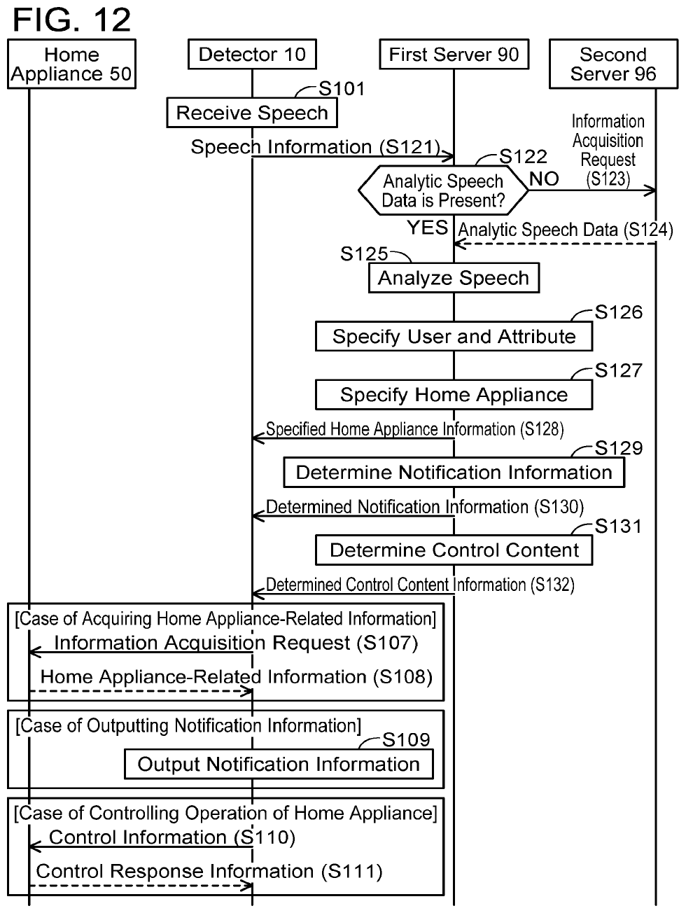

In the above embodiments, the controller 20 of the detector 10 specifies the user and his/her attribute, however, no limitation is made to this configuration, and the controller 91 of the first server 90 may specify the user and his/her attribute. In the control system 1 of the fourth embodiment, as shown in FIG. 12, a process of step S121 is executed following the above step S101. In step S121, the controller 20 of the detector 10 sends the information on the speech (such as “what do we have in the fridge?”) which the speech receiving unit 21 received in step S101 to the first server 90. This speech information is received by the controller 91 of the first server 90.

Next in step S122, the controller 91 of the first server 90 determines whether or not analytic speech data for analyzing the speech received in step S121 is present in the first server 90. In a case where the analytic speech data is present in the first server 90, the controller 91 determines YES to step S122 and proceeds to step S125. On the other hand, in a case where the analytic speech data is not present in the first server 90, the controller 91 determines NO to step S122 and executes a process of step S123.

In step S123, the controller 91 of the first server 90 sends information acquisition request to the external second server 96. This information acquisition request is received by a controller (not shown) of the second server 96. Then in step S124, the controller of the second server 96 sends the analytic speech data to the first server 90 in response to the received information acquisition request. The analytic speech data is present in the second server 96. This analytic speech data is received by the controller 91 of the first server 90.

Next in step S125, the controller 91 of the first server 90 analyzes the speech received in the above step S121 by using the analytic speech data received in the above step S124. The controller 91 analyzes the speech and extracts keyword(s) included in the speech. For example, the controller 91 analyzes the speech “what do we have in the fridge?” and extracts the keyword “fridge” included in the speech.

Next in step S126, the controller 91 of the first server 90 specifies the user who spoke the speech detected by the detector 10 and his/her attribute. The controller 91 specifies the user and his/her attribute based on the speech analysis using the analytic speech data. For example, the controller 91 analyzes a frequency of the speech (“what do we have in the fridge?”) received in the above step S121 and specifies the user who spoke the speech and his/her attribute by vocal print analysis and the like. For example, if a particular user 1 among the plurality of users 1 to 4 says “what do we have in the fridge?”, the controller 91 specifies this user 1. Further, the controller 91 specifies the attribute (such as being a male in his 50s) of this user 1.

Next in step S127, the controller 91 of the first server 90 specifies the home appliance 50 related to the keyword(s) based on the keyword(s) extracted by the speech analysis. For example, the controller 91 specifies, from among the plurality of home appliances 50 in the control system 1, the home appliance 50 related to the extracted keyword “fridge”, that is, the “refrigerator 50a”. Next in step S128, the controller 91 sends the home appliance information of the home appliance 50 (refrigerator 50a) specified in step S127 to the detector 10. This home appliance information is received by the controller 20 of the detector 10.

Next in step S129, the controller 91 determines the notification information. The controller 91 determines the notification information suitable for the user and his/her attribute specified in the above step S126. Further, the controller 91 determines the notification information suitable for the home appliance 50 specified in the above step S127. For example, in the case where the user 1 is specified in the above step S126 and the refrigerator 50a is specified in the above step S127, the controller 91 determines the notification information “we have beer and cheese.” (see FIG. 5). Further, for example, in the case where the user 1 is specified in the above step S126 and the TV 50f is specified in the above step S127, the controller 91 determines the notification information “switching the channel to a news program.” (see FIG. 5). Then in step S130, the controller 91 sends the notification information determined in step S129 to the detector 10. This notification information is received by the controller 20 of the detector 10.

Next in step S131, the controller 91 determines the control content for the home appliance 50 specified in the above step S127. At this occasion, the controller 91 determines the control content suitable for the user and his/her attribute specified in the above step S126. For example, in the case where the user 1 is specified in the above step S126 and the TV 50f is specified in the above step S127, the controller 91 determines the control content to “change the channel with priority to a news program.” (see FIG. 8). Then in step S132, the controller 91 sends the information on the control content determined in step S131 to the detector 10. This control content information is received by the controller 20 of the detector 10.

After this, the processes from step S107 to step S111 are executed based on the home appliance information, the notification information, and the control content information which the controller 20 of the detector 10 received in the above step S128, step S130, and step S132. Since the processes from step S107 to step S111 have been described in the first embodiment, detailed description thereof will be omitted.

According to the above configuration, since data is stored in the first server 90 in a larger volume than in the detector 10, the user and his/her attribute can be specified based on such large-volume data. According to this configuration, accuracy of the speech analysis becomes higher.

Specific examples of the present invention have been described in detail, however, these are mere exemplary indications and thus do not limit the scope of the claims. The art recited in the claims includes modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

### REFERENCE SIGNS LIST

1: control system
10: detector
12: microphone
13: speaker
14: wireless communication module
20: controller
21: speech receiving unit
22: audio output unit
23: storage unit
24: communication unit
50: home appliances
50a: refrigerator
50b: laundry machine
50c: robotic vacuum cleaner
50d: air conditioner
50e: water heater
50f: TV
60: controller
90: first server
91: controller
92: wireless router
93: modem
96: second server
100: Internet

1: A control system comprising:
a detector configured to detect speech of a plurality of users; and
a controller,
wherein the controller is configured to specify an attribute of the user who spoke based on a content and/or voice of the speech of the user detected by the detector, and output notification information suitable for the attribute and/or execute control suitable for the attribute.

2: The control system according to claim 1, wherein the controller specifies the user who spoke based on the voice of the speech of the user, and outputs the notification information suitable for the user and/or executes the control suitable for the user.

3: The control system according to claim 1, wherein the controller specifies the user based on a user-specific trigger word included in the speech of the user, and outputs the notification information suitable for the user and/or executes the control suitable for the user.

4: The control system according to claim 2, further comprising a plurality of home appliances capable of communicating with the detector,
wherein the controller outputs the notification information suitable for the user regarding the home appliances.

5: The control system according to claim 2, further comprising a plurality of home appliances capable of communicating with the detector,
wherein the controller executes the control suitable for the user regarding the home appliances.

6: The control system according to claim 2, wherein the controller outputs the notification information suitable for the specified user based on a past action history of the specified user.

7: The control system according to claim 4, further comprising a plurality of home appliances capable of communicating with the detector,
wherein the controller executes the control for the home appliances based on positional information associated with the specified user.
